(19) United States
(12) Patent Application Publication
(10) Pub. No.: US 2023/0367306 A1
(43) Pub. Date: Nov. 16, 2023

(54) METHOD AND APPARATUS FOR EQUIPMENT ANOMALY DETECTION

(71) Applicant: Industrial Technology Research Institute, Hsinchu (TW)

(72) Inventors: Po-Han Chang, Taichung City (TW); An-Chun Luo, Hsinchu County (TW); Tien I Kao, New Taipei City (TW); Ming-Ji Dai, Hsinchu City (TW); Yi-Jen Lin, Kinmen County (TW); Po-Huan Chou, Hsinchu County (TW)

(73) Assignee: Industrial Technology Research Institute, Hsinchu (TW)

(21) Appl. No.: 18/173,093

(22) Filed: Feb. 23, 2023

Related U.S. Application Data
(60) Provisional application No. 63/341,426, filed on May 13, 2022.

(30) Foreign Application Priority Data
Jun. 20, 2022 (TW) 111122909
Dec. 20, 2022 (TW) 111148853

(51) Int. Cl. G05B 23/02; G06N 20/00

(52) U.S. Cl. CPC G05B 23/0283; G06N 20/00

(57) ABSTRACT

A method and an apparatus for equipment anomaly detection are provided. In the method, multiple signals of an equipment during normal operation or appearance images of the equipment when an appearance is not damaged are acquired in advance by using a data acquisition device to train a machine learning model stored in a storage device. A real-time signal of the equipment during a current operation or a current image of the appearance of the equipment is acquired by using the data acquisition device, and input to the trained machine learning model to output a detection result indicating a current operation state of the equipment or a current state of the appearance of the equipment.

### CROSS-REFERENCE TO RELATED APPLICATION

This application claims the priority benefit of U.S. provisional application Ser. No. 63/341,426, filed on May 13, 2022, Taiwan application serial no. 111122909, filed on Jun. 20, 2022, and Taiwan application serial no. 111148853, filed on Dec. 20, 2022. The entirety of each of the above-mentioned patent applications is hereby incorporated by reference herein and made a part of this specification.

### NOTICE OF MATERIAL SUBJECT TO COPYRIGHT PROTECTION

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. The following notice shall apply to this document, the data and contents as described below, and the drawings hereto: Copyright© 2019-2023, https://www.kaggle.com/c/severstal-steel-defect-detection.

### BACKGROUND

### Technical Field

The disclosure relates to a method and an apparatus for equipment anomaly detection.

### Background

At present, artificial intelligence (AI) technology has been introduced into equipment and mechanical systems to greatly reduce the adverse effects, such as product yield decline and operation losses, caused by down time in the production line. Training an AI model generally requires collecting a large amount of normal and anomaly data. However, the aging and anomaly data of electrical or mechanical equipment are usually extremely difficult to obtain, and due to the wide variety of anomalies, it is difficult to collect sufficient data for each individual anomaly. As a result, the training data is unbalanced and the prediction performance of the AI model for detecting equipment anomalies decreases. Moreover, due to the lack of training data for detecting anomalies of electrical or mechanical equipment, it is difficult to train the machine learning model to determine whether there is an anomaly in the electrical or mechanical equipment.

### SUMMARY

An embodiment of the disclosure provides an apparatus for equipment anomaly detection, which includes a data acquisition device, a storage device, and a processor. The data acquisition device is used to acquire signals of an equipment during operation. The storage device is used to store machine learning models. The processor is connected to the data acquisition device and the storage device, and is configured to acquire multiple signals of the equipment during normal operation by using the data acquisition device to train the machine learning model; acquire a real-time signal of the equipment during a current operation by using the data acquisition device; and input the acquired real-time signal to the trained machine learning model to output a detection result indicating a current operation state of the equipment.

An embodiment of the disclosure provides a method for equipment anomaly detection, which is applicable to an electronic device including a data acquisition device, a storage device, and a processor. The method includes the following steps. Multiple signals of an equipment during normal operation are acquired in advance by using the data acquisition device to train a machine learning model stored in the storage device. A real-time signal of the equipment during a current operation is acquired by using the data acquisition device. The acquired real-time signal is input to the trained machine learning model to output a detection result indicating a current operation state of the equipment.

An embodiment of the disclosure provides an apparatus for equipment anomaly detection, which includes a data acquisition device, a storage device, and a processor. The data acquisition device is used to acquire an appearance image of an equipment. The storage device is used to store a machine learning model. The processor is connected to the data acquisition device and the storage device, and is configured to acquire multiple appearance images when an equipment appearance is not damaged in advance by using the data acquisition device to be used to train the machine learning model, acquire a current image of the equipment appearance by using the data acquisition device, and input the acquired current image into the trained machine learning model to output a detection result indicating a current state of the equipment appearance.

An embodiment of the disclosure provides a method for equipment anomaly detection, which is applicable to an electronic device including a data acquisition device, a storage device, and a processor. The method includes the following steps. Multiple appearance images when an equipment appearance is not damaged are acquired in advance by using the data acquisition device to be used to train a machine learning model stored in the storage device. A current image of the equipment appearance is acquired by using the data acquisition device, and the acquired current image is input into the trained machine learning model to output a detection result indicating a current state of the equipment appearance.

In order for the features and advantages of the disclosure to be more comprehensible, the following specific embodiments are described in detail in conjunction with the drawings.

### BRIEF DESCRIPTION OF THE DRAWINGS

FIG. 1 is a block diagram of an apparatus for equipment anomaly detection according to an embodiment of the disclosure.

FIG. 2 is a flowchart of a method for equipment anomaly detection according to an embodiment of the disclosure.

FIG. 3 is an example of a method for equipment anomaly detection according to an embodiment of the disclosure.

FIG. 4A and FIG. 4B are examples of training a machine learning model according to an embodiment of the disclosure.

FIG. 5 is an example of a method for equipment anomaly detection according to an embodiment of the disclosure.

FIG. 6A and FIG. 6B are examples of training a machine learning model according to an embodiment of the disclosure.

FIG. 7 is an example of a method for equipment anomaly detection according to an embodiment of the disclosure.

FIG. 8 is an example of training a machine learning model according to an embodiment of the disclosure.

FIG. 9 is an example of a method for equipment anomaly detection according to an embodiment of the disclosure.

FIG. 10A and FIG. 10B are examples of training a machine learning model according to an embodiment of the disclosure.

FIG. 11 is an example of a method for equipment anomaly detection according to an embodiment of the disclosure.

FIG. 12A and FIG. 12B are examples of training a machine learning model according to an embodiment of the disclosure.

FIG. 13 is an example of a method for equipment anomaly detection according to an embodiment of the disclosure.

FIG. 14 is an example of training a machine learning model according to an embodiment of the disclosure.

FIG. 15 is a flowchart of a method for equipment anomaly detection according to an embodiment of the disclosure.

### DETAILED DESCRIPTION OF DISCLOSED EMBODIMENTS

An embodiment of the disclosure provides a machine learning model that does not need to collect anomaly data of an electrical or mechanical equipment and can distinguish an equipment anomaly by sensing and collecting a large number of data of the equipment during normal operation for model training, so as to achieve the objective of intelligent pre-diagnosis. The model may combine time-domain and frequency-domain features of signals or combine image and image frequency-domain features for comprehensive prediction to obtain better accuracy, and prediction of signal data may be performed through connecting an external artificial intelligence (AI) edge computing module to the electrical or mechanical equipment.

The disclosure provides a method and an apparatus for equipment anomaly detection, which can complete the training of a machine learning model and distinguish an equipment anomaly under the condition of collecting normal data.

The method and the apparatus for equipment anomaly detection of the disclosure can distinguish the equipment anomaly through sensing and collecting a large amount of data of the equipment during normal operation to train the machine learning model. Through combining a time-domain signal and a frequency-domain signal to train the machine learning model, better accuracy can be obtained. The trained machine learning model may be stored in an external device, thereby implementing edge computing and intelligent pre-diagnosis.

FIG. 1 is a block diagram of an apparatus for equipment anomaly detection according to an embodiment of the disclosure. Please refer to FIG. 1. An apparatus for equipment anomaly detection 10 of the embodiment is, for example, a personal computer, a server, a workstation, or other apparatuses with computing functions, and includes a data acquisition device 12, a storage device 14, and a processor 16, and the functions thereof are described as follows.

The data acquisition device 12 is, for example, a wired connection device such as a universal serial bus (USB), RS232, a universal asynchronous receiver/transmitter (UART), an internal integrated circuit (I2C), a serial peripheral interface (SPI), a display port, a thunderbolt, or a local area network (LAN) interface, or a wireless connection device supporting communication protocol such as wireless fidelity (Wi-Fi), RFID, Bluetooth, infrared, near-field communication (NFC), or device-to-device (D2D), which is not limited thereto. The data acquisition device 12 may be connected to a local or remote equipment 20 or a sensor disposed on the equipment 20 and is used to acquire a signal, such as a voltage signal, a current signal, a sound signal, or a vibration signal, of the equipment 20 during operation, which is not limited thereto.

The storage device 14 is, for example, any type of fixed or removable random-access memory (RAM), read-only memory (ROM), flash memory, hard disk drive, other similar devices, or a combination of the devices to store a program executable by the processor 16. In some embodiments, the storage device 14 may store a machine learning model established by using equipment operation information. The machine learning model is, for example, a convolutional neural network (CNN), a recurrent neural network (RNN), or a long short-term memory (LSTM) recurrent neural network, which is not limited by the disclosure.

The processor 16 is, for example, coupled to the data acquisition device 12 and the storage device 14 through a bus bar 18 to control the operation of the apparatus for equipment anomaly detection 10. In some embodiments, the processor 16 is, for example, a central processing unit (CPU), other programmable general-purpose or specific-purpose microprocessors, digital signal processors (DSPs), programmable controllers, application specific integrated circuits (ASICs), field programmable gate arrays (FPGAs), programmable logic controllers (PLCs), other similar devices, or a combination of the devices to load and execute the program stored in the storage device 14, so as to execute the method for equipment anomaly detection of the embodiment of the disclosure.

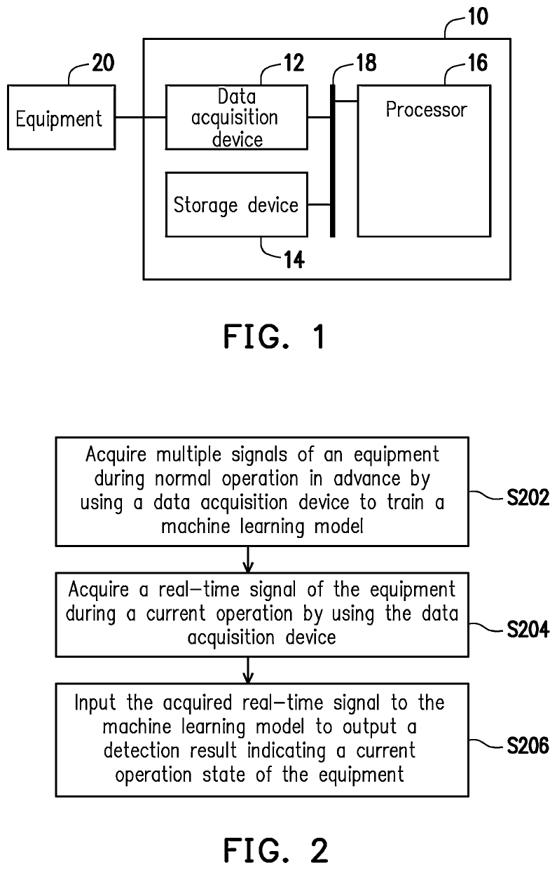

FIG. 2 is a flowchart of a method for equipment anomaly detection according to an embodiment of the disclosure. Please refer to FIG. 1 and FIG. 2 at the same time. The method of the embodiment is applicable to the apparatus for equipment anomaly detection 10 in FIG. 1. The following describes the detailed steps of the method for equipment anomaly detection according to the embodiment of the disclosure in conjunction with various elements of the apparatus for equipment anomaly detection 10.

In Step S202, the processor 16 of the apparatus for equipment anomaly detection 10 acquires multiple signals of the equipment 20 during normal operation in advance by using the data acquisition device 12 to train a machine learning model. Taking a motor of a robotic arm as an example, the processor 16 may acquire voltage signals and current signals of the motor of the robotic arm during normal operation, but not limited thereto. In other embodiments, the processor 16 may also acquire a sound signal, a vibration signal, or other signals of the motor of the robotic arm during normal operation, which is not limited thereto.

In Step S204, the processor 16 acquires a real-time signal of the equipment 20 during a current operation by using the data acquisition device 12. The equipment 20 is, for example, a source equipment of the signal acquired during the previous training of the machine learning model or an equipment of the same type as the source equipment, which is not limited thereto. In other words, the trained machine learning model may be used to detect an operation state of the equipment of the same type.

In Step S206, the processor 16 inputs the acquired real-time signal to the machine learning model to output a detection result indicating a current operation state of the equipment 20. In the embodiment, a large number of signals of the equipment 20 during normal operation are collected to train the machine learning model, so even in the absence of a signal of an anomaly of the equipment 20, the machine learning model can distinguish the anomaly of the equipment 20, so as to achieve the effect of intelligent pre-diagnosis.

In some embodiments, the machine learning model is formed by connecting an encoder composed of an neural network to an outlier detection model (ODM). The outlier detection model is, for example, a one-class support vector machine (OCSVM), an isolation forest, a local outlier factor (LOF), etc., but not limited thereto.

The processor 16, for example, inputs the real-time signal of the equipment 20 during the current operation acquired by the data acquisition device 12 to a trained encoder, and the encoder performs feature extraction and dimension reduction on the input signal to output compressed representation data of the signal. Then, the processor 16 inputs the compressed representation data to the trained outlier detection model to distinguish the current operation state of the equipment 20 and output the detection result.

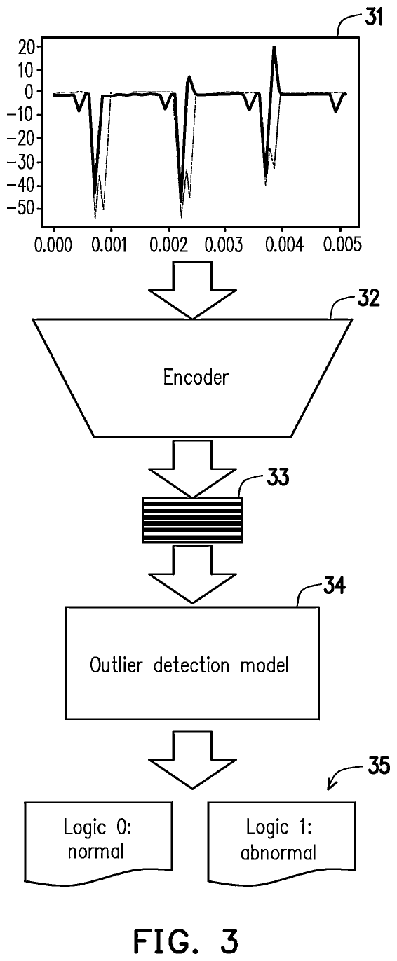

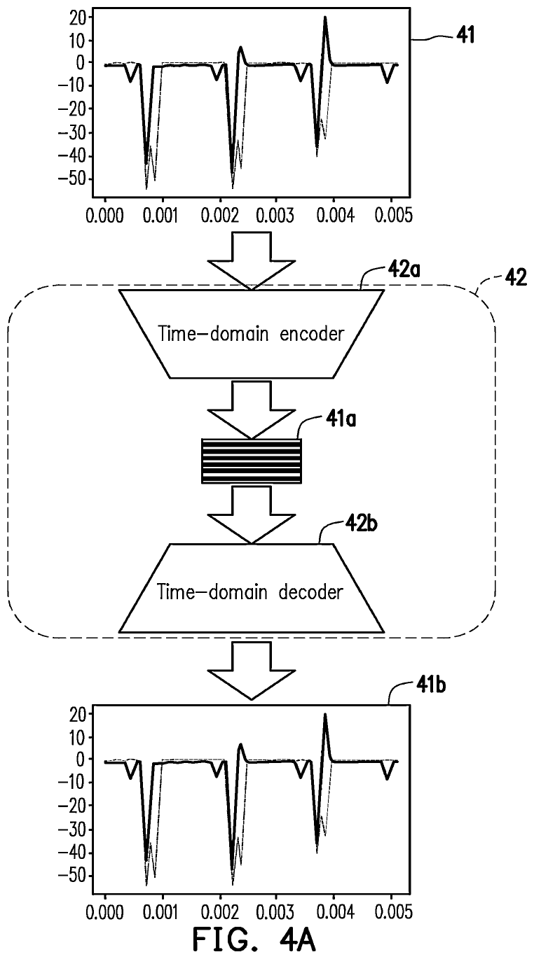

For example, FIG. 3 is an example of a method for equipment anomaly detection according to an embodiment of the disclosure. Please refer to FIG. 3. An apparatus for equipment anomaly detection of the embodiment acquires voltage signals 31 of an equipment during a current operation, and inputs the voltage signals 31 to a trained encoder 32. The encoder 32 performs feature extraction and dimension reduction on the voltage signals 31 to output compressed representation data 33 of the signals. Then, the apparatus for equipment anomaly detection inputs the compressed representation data 33 to a trained outlier detection model 34 to distinguish a current operation state of the equipment and output a detection result 35. For example, when the current operation state of the equipment is distinguished to be normal, the detection result 35 of logic 0 is output, and when the current operation state of the equipment is distinguished to be abnormal, the detection result 35 of logic 1 is output.

The encoder 32 and the outlier detection model are both pre-trained. For example, the encoder is trained first, and the outlier detection model is then trained.

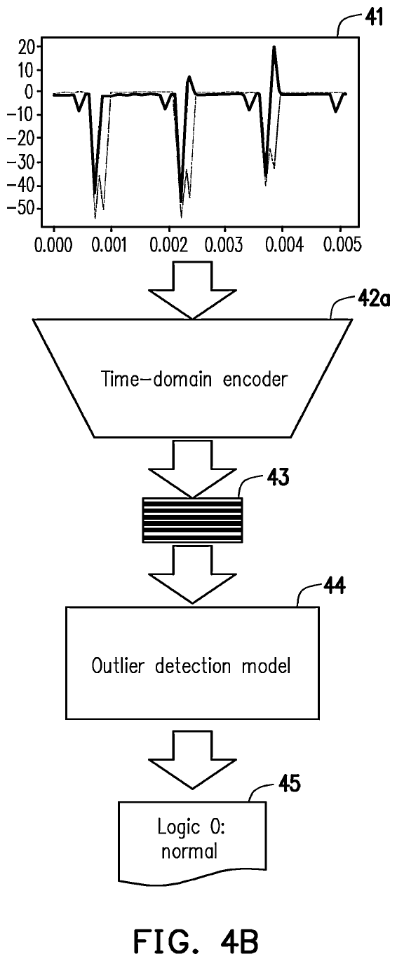

For example, FIG. 4A and FIG. 4B are examples of training a machine learning model according to an embodiment of the disclosure. The training of the embodiment includes the training of a time-domain autoencoder 42 shown in FIG. 4A and the training of an outlier detection model 44 shown in FIG. 4B. Please refer to FIG. 4A. The time-domain autoencoder 42 of the embodiment includes a time-domain encoder 42a and a time-domain decoder 42b. The training of the time-domain autoencoder 42 is, for example, to input a time-domain signal 41 of an equipment acquired during normal operation to the time-domain encoder 42a, and the time-domain encoder 42a performs feature extraction and dimension reduction on the time-domain signal 41 to output compressed representation data 41a of the time-domain signal 41. Then, the time-domain decoder 42b decodes the compressed representation data 41a to obtain a reconstructed time-domain signal 41b. In the embodiment, a loss function between the time-domain signal 41 and the reconstructed time-domain signal 41b is calculated to train the time-domain autoencoder 42. In some embodiments, weights in the time-domain encoder 42a and the time-domain decoder 42b (for example, weights in hidden layers of neural network) are optimized by, for example, adopting manners that can minimize the loss function, such as a stochastic gradient descent (SGD) method, which is not limited thereto.

Please refer to FIG. 4B. After the training of the time-domain autoencoder 42 is completed, in the embodiment, the weight in the trained time-domain encoder 42a is fixed, and the time-domain encoder 42a is connected to the outlier detection model 44 to train the outlier detection model 44. In the embodiment, the time-domain signal 41 of the equipment acquired during normal operation is input to the trained time-domain encoder 42a to output encoded compressed representation data 43. Then, the compressed representation data 43 is input to the outlier detection model 44 and the output of the outlier detection model 44 is set to a detection result 45 of a normal operation state (for example, logic 0), so as to train the outlier detection model 44.

Through the above method, in the embodiment of the disclosure, the easily collected time-domain signal of the equipment in the normal operation state is used to train the machine learning model, and there is no need to collect or use equipment anomaly data. Therefore, the issue of poor prediction performance caused by unbalanced data categories can be solved.

In the embodiment, the time-domain signal is used to train the machine learning model which is used to distinguish the current operation state of the equipment. In other embodiments, the disclosure may also use frequency-domain signals to train the machine learning model or simultaneously use the time-domain and frequency-domain signals to train the machine learning model and to distinguish the current operation state of the equipment, which can also achieve the intelligent pre-diagnosis.

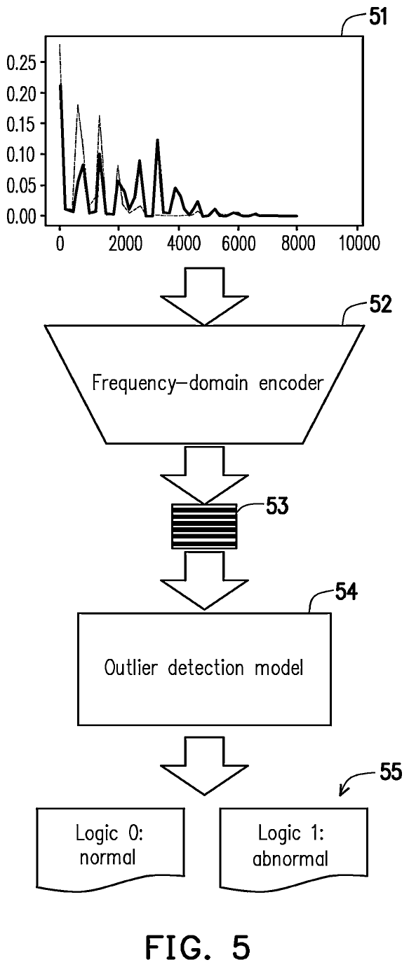

For example, FIG. 5 is an example of a method for equipment anomaly detection according to an embodiment of the disclosure. Please refer to FIG. 5. An apparatus for equipment anomaly detection of the embodiment acquires a frequency-domain signal 51 of an equipment during a current operation. The frequency-domain signal 51 can be represented by a power spectral density (PSD), but is not limited thereto. In some embodiments, the apparatus for equipment anomaly detection acquires a time-domain signal (such as a voltage signal, a current signal, a sound signal, or a vibration signal) of the equipment during the current operation, and then executes fast Fourier transform (FFT) on the acquired time-domain signal, thereby obtaining the frequency-domain signal 51. In other embodiments, the apparatus for equipment anomaly detection directly acquires the frequency-domain signal 51 of the equipment during the current operation. The embodiment does not limit the obtaining manner of the frequency-domain signal 51.

The apparatus for equipment anomaly detection inputs the currently acquired frequency-domain signal 51 to a trained frequency-domain encoder 52, and the frequency-domain encoder 52 performs feature extraction and dimension reduction on the frequency-domain signal 51 to output compressed representation data 53 of the signal 51. Then, the apparatus for equipment anomaly detection inputs the compressed representation data 53 to a trained outlier detection model 54 to distinguish a current operation state of the equipment and to output a detection result 55. For example, when the current operation state of the equipment is distinguished to be normal, the detection result 55 of logic 0 is output, and when the current operation state of the equipment is distinguished to be abnormal, the detection result 55 of logic 1 is output.

Similar to the embodiment in FIG. 4A and FIG. 4B, the apparatus for equipment anomaly detection of the embodiment, for example, first trains an autoencoder, and then trains the outlier detection model.

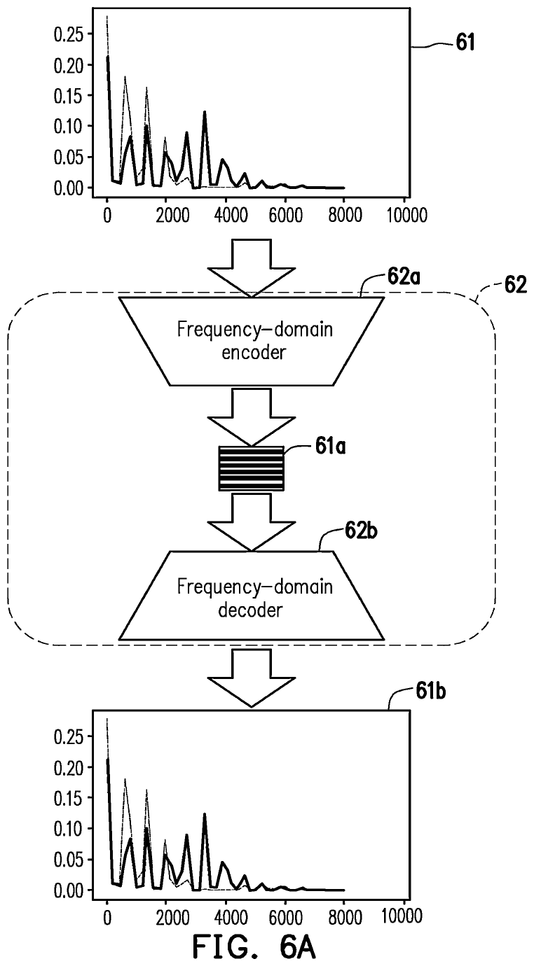

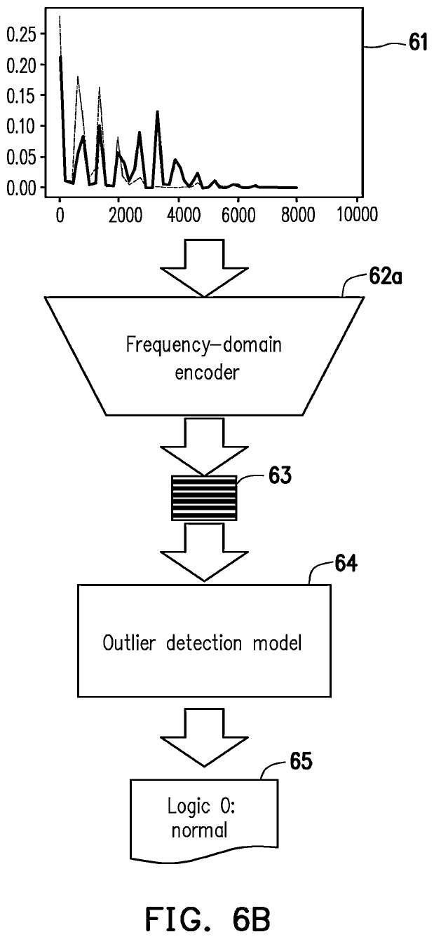

For example, FIG. 6A and FIG. 6B are examples of training a machine learning model according to an embodiment of the disclosure. The training of the embodiment includes the training of a frequency-domain autoencoder 62 shown in FIG. 6A and the training of an outlier detection model 64 shown in FIG. 6B. Please refer to FIG. 6A. The frequency-domain autoencoder 62 of the embodiment includes a frequency-domain encoder 62a and a frequency-domain decoder 62b. The training of the frequency-domain autoencoder 62 is, for example, to input a frequency-domain signal 61 of an equipment acquired during normal operation to the frequency-domain encoder 62a, and the frequency-domain encoder 62a performs feature extraction and dimension reduction on the frequency-domain signal 61 to output compressed representation data 61a of the frequency-domain signal 61. Then, the frequency-domain decoder 62b decodes the compressed representation data 61a to obtain a reconstructed frequency-domain signal 61b. In the embodiment, a loss function between the frequency-domain signal 61 and the reconstructed frequency-domain signal 61b is calculated to train the frequency-domain autoencoder 62. In some embodiments, weights in the frequency-domain encoder 62a and the frequency-domain decoder 62b are optimized by, for example, adopting manners that can minimize the loss function, such as a stochastic gradient descent method, which is not limited thereto.

Please refer to FIG. 6B. After the training of the frequency-domain autoencoder 62 is completed, in the embodiment, the weight in the trained frequency-domain encoder 62a is fixed and connected to the outlier detection model 64 to train the outlier detection model 64. In the embodiment, the frequency-domain signal 61 of the equipment acquired during normal operation is input to the trained frequency-domain encoder 62a to output encoded compressed representation data 63. Then, the compressed representation data 63 is input to the outlier detection model 64 and the output of the outlier detection model 64 is set to a detection result 65 of a normal operation state (for example, logic 0).

Through the above method, in the embodiment of the disclosure, the easily collected frequency-domain signal of the equipment in the normal operation state is used to train the machine learning model, and there is no need to collect or use equipment anomaly data. Therefore, the issue of poor machine learning effect caused by data imbalance can be solved.

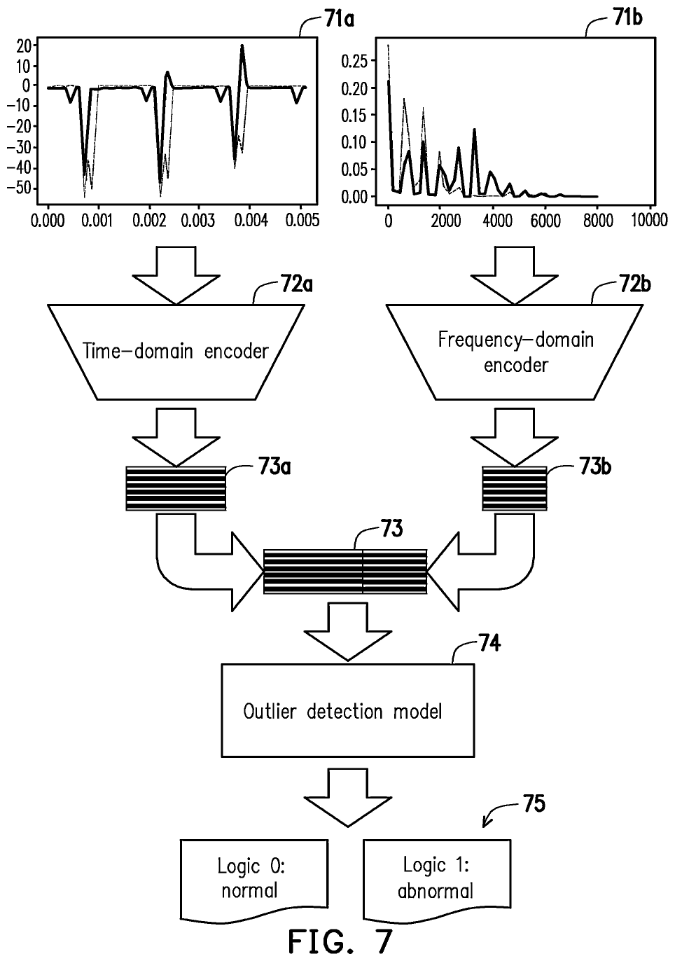

On the other hand, FIG. 7 is an example of a method for equipment anomaly detection according to an embodiment of the disclosure. Please refer to FIG. 7. An apparatus for equipment anomaly detection of the embodiment simultaneously acquires a time-domain signal 71a and a frequency-domain signal 71b of an equipment during a current operation. In some embodiments, the apparatus for equipment anomaly detection executes fast Fourier transform on the time-domain signal 71a (for example, a voltage signal, a current signal, a sound signal, or a vibration signal) of the equipment acquired during the current operation, thereby obtaining the frequency-domain signal 71b. In other embodiments, the apparatus for equipment anomaly detection directly acquires the frequency-domain signal 71b of the equipment during the current operation. The embodiment does not limit the obtaining manner of the frequency-domain signal 71b.

The apparatus for equipment anomaly detection inputs the currently acquired time-domain signal 71a to a trained time-domain encoder 72a, and the time-domain encoder 72a performs feature extraction and dimension reduction on the time-domain signal 71a to output compressed representation data 73a of the time-domain signal 71a. In addition, the apparatus for equipment anomaly detection also inputs the currently acquired frequency-domain signal 71b to a trained frequency-domain encoder 72b, and the frequency-domain encoder 72b performs feature extraction and dimension reduction on the frequency-domain signal 71b to output compressed representation data 73b of the frequency-domain signal 71b. Then, the apparatus for equipment anomaly detection concatenates the compressed representation data 73a of the time-domain signal 71a and the compressed representation data 73b of the frequency-domain signal 71b into compressed representation data 73, and inputs the compressed representation data 73 to a trained outlier detection model 74 to distinguish a current operation state of the equipment and output a detection result 75. For example, when the current operation state of the equipment is distinguished to be normal, the detection result 75 of logic 0 is output, and when the current operation state of the equipment is distinguished to be abnormal, the detection result 75 of logic 1 is output.

Similar to the embodiments in FIG. 4A and FIG. 6A, the apparatus for equipment anomaly detection, for example, respectively trains a time-domain autoencoder and a frequency-domain autoencoder. The apparatus for equipment anomaly detection performs feature extraction and dimension reduction on the time-domain signal of the equipment during normal operation by using the time-domain encoder in the time-domain autoencoder, then reconstructs the time-domain signal by a time-domain decoder, and then calculates a loss function between the time-domain signal and the reconstructed time-domain signal to train the time-domain autoencoder. The apparatus for equipment anomaly detection also performs feature extraction and dimension reduction on the frequency-domain signal of the equipment during normal operation by using the frequency-domain encoder in the frequency-domain autoencoder, then reconstructs the frequency-domain signal by a frequency-domain decoder, and then calculates a loss function between the frequency-domain signal and the reconstructed frequency-domain signal to train the frequency-domain autoencoder. The manners of training the time-domain autoencoder and training the frequency-domain autoencoder in the embodiment are the same as or similar to the above manners of training the time-domain autoencoder 42 in FIG. 4A and training the frequency-domain autoencoder 62 in FIG. 6A, so the detailed content will not be repeated here.

Different from the foregoing embodiments, in the apparatus for equipment anomaly detection of the embodiment, weights in the trained time-domain encoder and the frequency-domain encoder are fixed and connected the outlier detection model to train the outlier detection model.

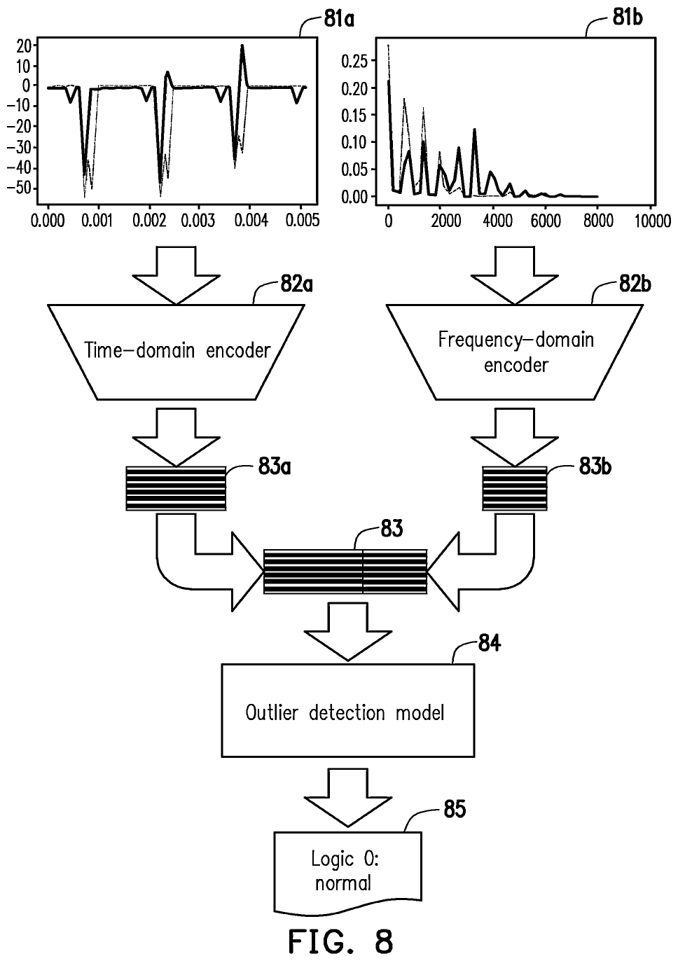

FIG. 8 is an example of training a machine learning model according to an embodiment of the disclosure. Please refer to FIG. 8. An apparatus for equipment anomaly detection respectively inputs a time-domain signal 81a and a frequency-domain signal 81b of an equipment acquired during normal operation to a trained time-domain encoder 82a and frequency-domain encoder 82b to output encoded compressed representation data 83a of the time-domain signal 81a and compressed representation data 83b of the frequency-domain signal 81b. Then, the compressed representation data 83a of the time-domain signal 81a and the compressed representation data 83b of the frequency-domain signal 81b are concatenated into compressed representation data 83. The concatenated compressed representation data 83 is input to an outlier detection model 84 and the output of the outlier detection model 84 is set to a detection result 85 of a normal operation state (for example, logic 0), so as to train the outlier detection model 84.

Through the above method, in the embodiment of the disclosure, the easily collected time-domain signal and frequency-domain signal of the equipment in the normal operation state are used to train the machine learning model, and there is no need to collect or use equipment anomaly data. Therefore, the issue of low performance of machine learning caused by imbalanced data can be solved.

Table 1 below shows an accuracy comparison table of a machine learning model trained by adopting time-domain signals (hereinafter referred to as a time-domain model), a machine learning model trained by adopting frequency-domain signals (hereinafter referred to as a frequency-domain model), and a machine learning model trained by simultaneously adopting time-domain signals and frequency-domain signals (hereinafter referred to as a hybrid model). In the embodiment, the outlier detection model is one-class support vector machine (OCSVM), but is not limited thereto. It can be seen from Table 1 that for prediction through the time-domain model of the embodiment of the disclosure, the inference accuracy of normal signals is 99.87% and the inference accuracy of abnormal signals is 91.68%; for prediction through the frequency-domain model of the embodiment of the disclosure, the inference accuracy of normal signals is 93.98% and the inference accuracy of abnormal signals is 100.0%; however, for prediction through the hybrid model of the embodiment of the disclosure, the inference accuracy of normal signals is 99.04% and the inference accuracy of abnormal signals is 100.0%. In other words, for prediction through the hybrid model trained by simultaneously adopting the time-domain signals and the frequency-domain signals, the normal and abnormal signals can both be predicted with better accuracy.

TABLE 1

| | Accuracy | Accuracy |
|---|---|---|
| Model | (normal signals) | (abnormal signals) |
| Time-domain model | 99.87% | 91.68% |
| Frequency-domain model | 93.98% | 100.0% |
| Hybrid model | 99.04% | 100.0% |

In some embodiments, the data acquisition device 12 in the apparatus for equipment anomaly detection 10 includes, for example, a charge coupled device (CCD), a complementary metal-oxide semiconductor (CMOS) element or cameras of other types of photosensitive elements for acquiring an appearance image of an equipment to be detected. In other embodiments, the data acquisition device 12 is, for example, an interface such as a universal serial bus (USB), RS232, Bluetooth (BT), wireless fidelity (Wi-Fi), and other wired or wireless transmission interfaces for connecting to a camera to receive the appearance image of the equipment acquired by the camera. The embodiment of the disclosure does not limit the type and the function of the data acquisition device 12.

The processor 16 of the apparatus for equipment anomaly detection 10, for example, inputs a current image of the equipment acquired by the data acquisition device 12 into a trained encoder, and the encoder performs feature extraction and dimension reduction on the current image, so as to output a compressed representation data of the image. Then, the processor 16 inputs the compressed representation data into a trained outlier detection model to distinguish a current state of the appearance of the equipment 20 and output a detection result.

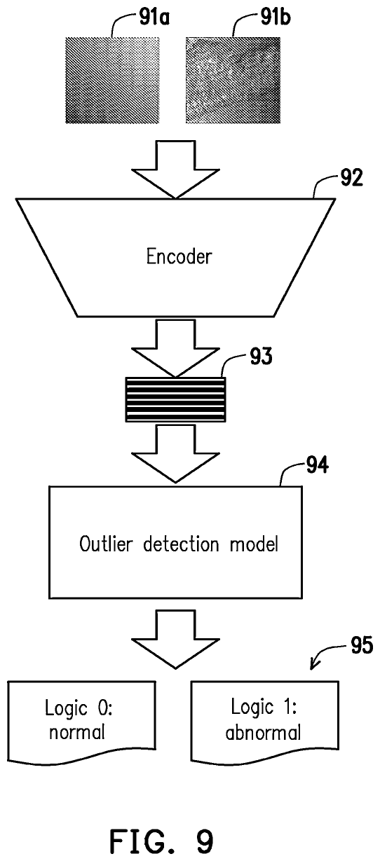

For example, FIG. 9 is an example of a method for equipment anomaly detection according to an embodiment of the disclosure. Please refer to FIG. 9. An apparatus for equipment anomaly detection of the embodiment is used to detect whether a metal surface of an equipment appearance is damaged, such as acquiring an appearance image (for example, an undamaged appearance image 91a or a damaged appearance image 91b) of the equipment by using a camera, and inputting the appearance image into a trained encoder 92. The encoder 92 performs feature extraction and dimension reduction on the appearance image to output compressed representation data 93 of the appearance image. Then, the apparatus for equipment anomaly detection inputs the compressed representation data 93 into a trained outlier detection model 94 to distinguish a current state of the equipment appearance and output a detection result 95. For example, when the current state of the equipment appearance is distinguished to be normal, the detection result 95 of logic 0 is output, and when the current state of the equipment appearance is distinguished to be abnormal, the detection result 95 of logic 1 is output.

The encoder and the outlier detection model are both pre-trained. For example, the encoder is trained first, and the outlier detection model is then trained.

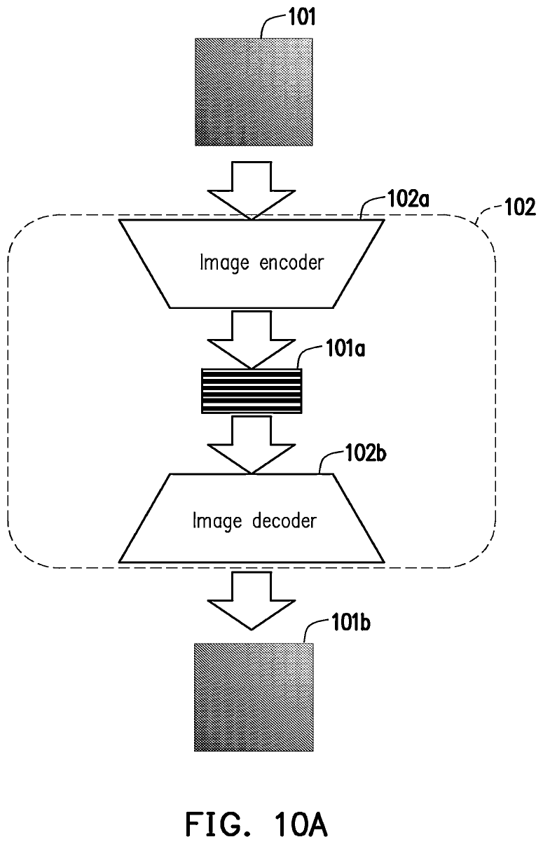

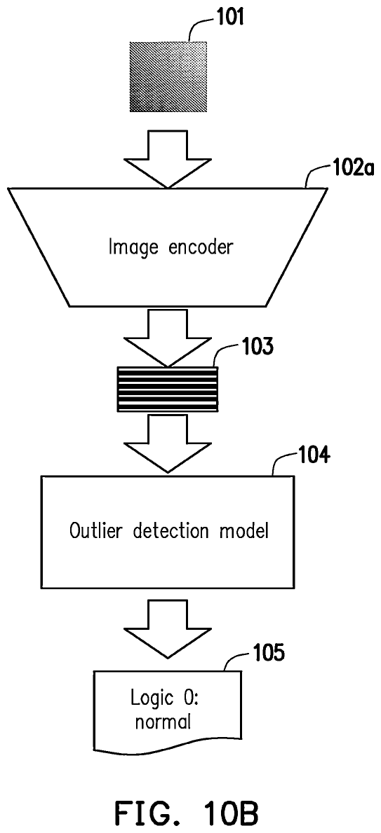

For example, FIG. 10A and FIG. 10B are examples of training a machine learning model according to an embodiment of the disclosure. The training of the embodiment includes the training of an image autoencoder 102 shown in FIG. 10A and the training of an outlier detection model 104 shown in FIG. 4B. Please refer to FIG. 10A. The image autoencoder 102 of the embodiment includes an image encoder 102a and an image decoder 102b. The training of the image autoencoder 102 is, for example, to use appearance images 101 acquired when the equipment appearance is normal to train the image autoencoder 102. The image encoder 102a performs feature extraction and dimension reduction on the appearance images 101 to output compressed representation data 101a of the appearance images 101. Then, the compressed presentation data 101a is decoded by the image decoder 102b to obtain a reconstructed appearance images 101b. In the embodiment, a loss function between the appearance images 101 and the reconstructed appearance images 101b is calculated and used to train the image autoencoder 102. In some embodiments, weights in the image encoder 102a and the image decoder 102 (for example, weights in hidden layers of a neural network) are optimized by, for example, adopting manners that can minimize the loss function, such as a stochastic gradient descent method, which is not limited thereto.

Please refer to FIG. 10B. After the image autoencoder 102 is trained, in the embodiment, the weights in the trained image encoder 102a are fixed and the outlier detection model 104 is connected to train the outlier detection model 104. Specifically, in the embodiment, the appearance images 101 acquired when the equipment appearance is normal are input into the trained image encoder 102a to output encoded compressed representation data 103. Then, the compressed representation data 103 is input into the outlier detection model 104 and the output of the outlier detection model 104 is set as a detection result 105 of a normal appearance state (for example, logic 0), so as to train the outlier detection model 104.

Through the above method, in the embodiment of the disclosure, the machine learning model is trained by using the easily collected appearance images when the equipment appearance is normal without the need to collect or use data of abnormal equipment appearance. Therefore, the issue of the low accuracy of the machine learning model caused by unbalanced data categories can be solved.

In the embodiment, the image is used to train the machine learning model and is used to distinguish the current appearance state of the equipment. In other embodiments, the disclosure may also use the image frequency-domain signal to train the machine learning model or simultaneously use the image and the image frequency-domain signal to train the machine learning model and to distinguish the current appearance state of the equipment, which can also achieve the intelligent pre-diagnosis.

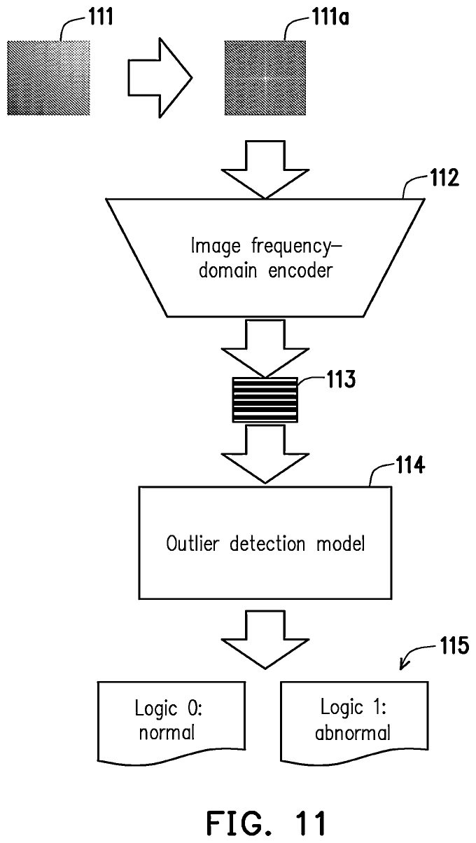

For example, FIG. 11 is an example of a method for equipment anomaly detection according to an embodiment of the disclosure. Please refer to FIG. 11. An apparatus for equipment anomaly detection of the embodiment is used to detect whether a metal surface of an equipment appearance is damaged. For example, multiple appearance images 111 of the equipment appearance are acquired when the equipment appearance is not damaged by using a camera. Then, fast Fourier transform (FFT) is executed on the acquired appearance images 111 to obtain a two-dimensional image frequency-domain signal 111a.

The apparatus for equipment anomaly detection inputs the transformed two-dimensional image frequency-domain signal 111a into a trained image frequency-domain encoder 112. The image frequency-domain encoder 112 performs feature extraction and dimension reduction on the two-dimensional image frequency-domain signal 111a to output compressed representation data 113 of the signal. Then, the apparatus for equipment anomaly detection inputs the compressed representation data 113 into a trained outlier detection model 114 to distinguish a current appearance state of the equipment and output a detection result 115. For example, when the current state of the equipment appearance is distinguished to be normal, the detection result 115 of logic 0 is output, and when the current state of the equipment appearance is distinguished to be abnormal, the detection result 115 of logic 1 is output.

The same as the embodiment of FIG. 10A and FIG. 10B, the apparatus for equipment anomaly detection of the embodiment, for example, first trains an autoencoder, and then trains the outlier detection model.

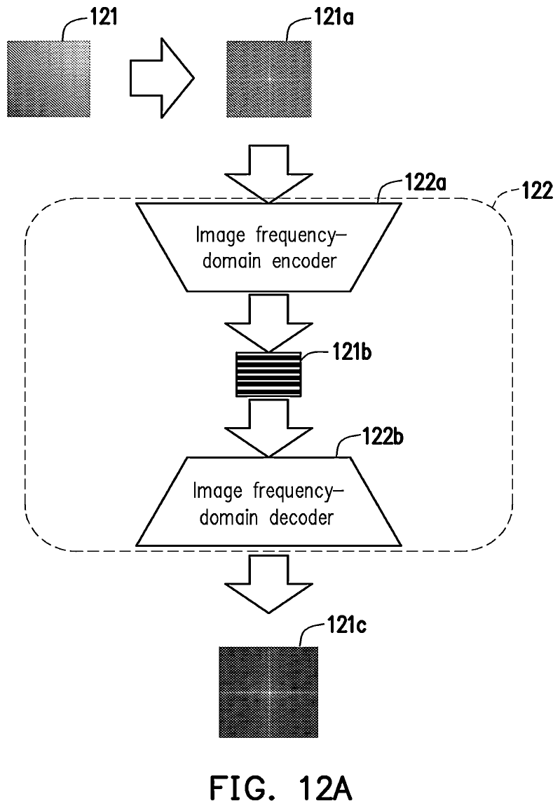

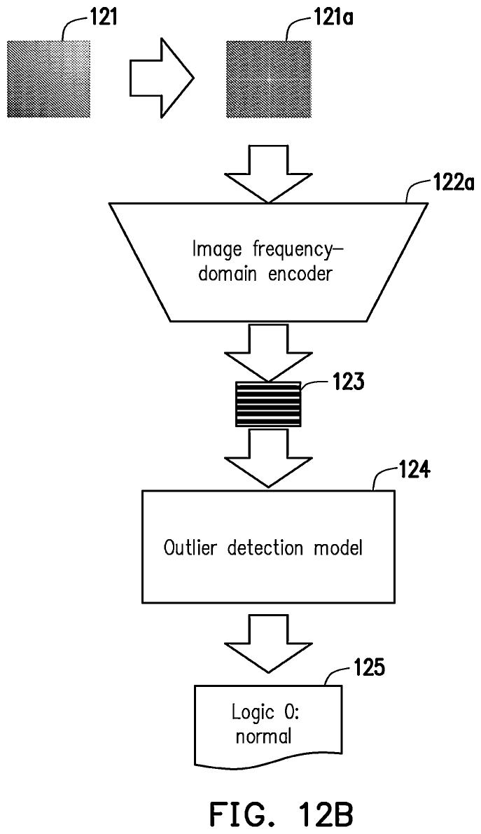

For example, FIG. 12A and FIG. 12B are examples of training a machine learning model according to an embodiment of the disclosure. The training of the embodiment includes the training of an image frequency-domain autoencoder 122 shown in FIG. 12A and the training of an outlier detection model 124 shown in FIG. 12B. Please refer to FIG. 12A. The image frequency-domain autoencoder 122 of the embodiment includes an image frequency-domain encoder 122a and an image frequency-domain decoder 122b. The training of the image frequency-domain autoencoder 122 is, for example, to transform appearance images 121 acquired when the equipment appearance is normal into a two-dimensional image frequency-domain signals 121a via fast Fourier transform (FFT), and then input into the image frequency-domain encoder 122a. The image frequency-domain encoder 122a performs feature extraction and dimension reduction on the two-dimensional image frequency-domain signals 121a to output compressed representation data 121b of the two-dimensional image frequency-domain signals 121a. Then, the compressed representation data 121b is decoded by the image frequency-domain decoder 122b to obtain a reconstructed two-dimensional image frequency-domain signals 121c. In the embodiment, a loss function between the two-dimensional image frequency-domain signals 121a and the reconstructed two-dimensional image frequency-domain signals 121c is calculated and used to train the image frequency-domain encoder 122a. In some embodiments, weights in the image frequency-domain encoder 122 a and the image frequency-domain decoder 122b are optimized by, for example, adopting manners that can minimize the loss function, such as a stochastic gradient descent method, which is not limited thereto.

Please refer to FIG. 12B. After the image frequency-domain autoencoder 122 is trained, in the embodiment, the weights in the trained image frequency-domain encoder 122a are fixed and the outlier detection model 124 is connected to train the outlier detection model 124. Specifically, in the embodiment, the appearance images 121 acquired when the equipment appearance is normal is transformed into the two-dimensional image frequency-domain signals 121a via fast Fourier transform (FFT), and then input into the trained image frequency-domain encoder 122a to output encoded compressed representation data 123. Then, the compressed representation data 123 is input into the outlier detection model 124 and the output of the outlier detection model 124 is set as a detection result 125 of a normal appearance state (for example, logic 0), so as to train the outlier detection model 124.

Through the above method, in the embodiment of the disclosure, the machine learning model is trained by using the easily collected appearance images (transformed into the two-dimensional image frequency-domain signals) when the appearance state is normal without the need to collect or use data of abnormal equipment appearance. Therefore, the issue of the low accuracy of the machine learning model caused by unbalanced data categories can be solved.

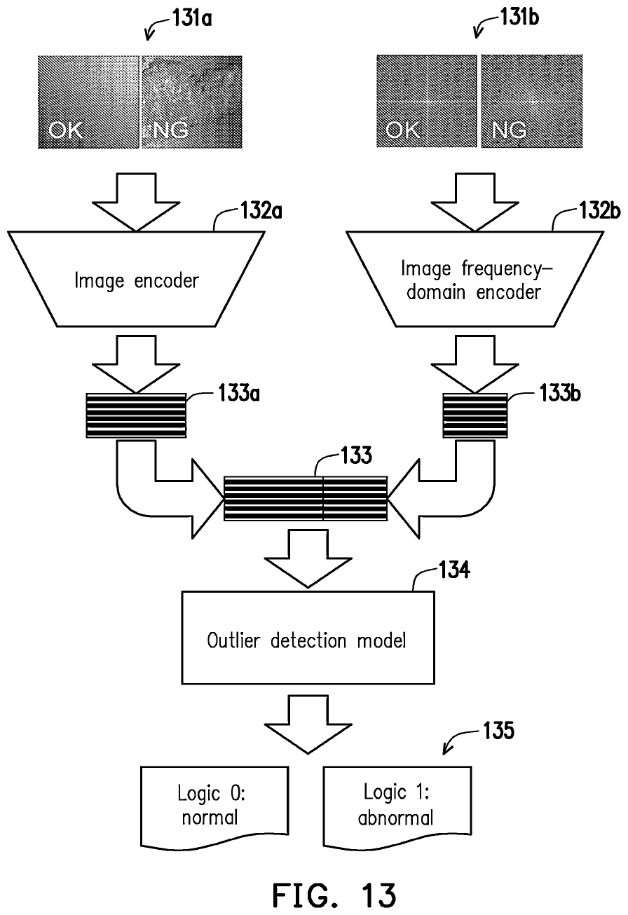

On the other hand, FIG. 13 is an example of a method for equipment anomaly detection according to an embodiment of the disclosure. Please refer to FIG. 13. The apparatus for equipment anomaly detection of the embodiment acquires a current appearance image 131a (an OK image of undamaged appearance or an NG image of damaged appearance) of the equipment, and executes fast Fourier transform (FFT) on the appearance image 131a to be transformed into a two-dimensional image frequency-domain signal 131b (an OK spectrum signal of undamaged appearance or an NG spectrum signal of damaged appearance).

The apparatus for equipment anomaly detection inputs the current appearance image 131a of the equipment into a trained image encoder 132a, and the image encoder 132a performs feature extraction and dimension reduction on the appearance image 131a to output compressed representation data 133a of the appearance image 131a. In addition, the apparatus for equipment anomaly detection also inputs the two-dimensional image frequency-domain signal 131b into a trained image frequency-domain encoder 132b, and the image frequency-domain encoder 132b performs feature extraction and dimension reduction on the two-dimensional image frequency-domain signal 131b to output compressed representation data 133b of the two-dimensional image frequency-domain signal 131b. Then, the apparatus for equipment anomaly detection splices the compressed representation data 133a of the appearance image 131a and the compressed representation data 133b of the two-dimensional image frequency-domain signal 131b into compressed representation data 133, and inputs the compressed representation data 133 into a trained outlier detection model 134 to distinguish a current appearance state of the equipment and output a detection result 135. For example, when the current state of the equipment appearance is distinguished to be normal, the detection result 135 of logic 0 is output, and when the current state of the equipment appearance is distinguished to be abnormal, the detection result 135 of logic 1 is output.

The same as the embodiments of FIG. 10A and FIG. 12A, the apparatus for equipment anomaly detection, for example, respectively trains the image autoencoder and the image frequency-domain autoencoder. The apparatus for equipment anomaly detection performs feature extraction and dimension reduction on the appearance images acquired when the equipment appearance is normal by the image encoder in the image autoencoder, then reconstructs the appearance images by the image decoder, and then calculates a loss function between the appearance images and the reconstructed appearance images to train the image autoencoder. The apparatus for equipment anomaly detection also performs feature extraction and dimension reduction on the two-dimensional image frequency-domain signals obtained via fast Fourier transform (FFT) of the appearance images acquired when the equipment appearance is normal by the image frequency-domain encoder in the image frequency-domain autoencoder, then reconstructs the two-dimensional image frequency-domain signals by the image frequency-domain decoder, and then calculates a loss function between the two-dimensional image frequency-domain signals and the reconstructed two-dimensional image frequency-domain signals to train the image frequency-domain autoencoder. The manners of training the image autoencoder and training the image frequency-domain autoencoder in the embodiment are the same as or similar to the above manners of training the image autoencoder 102 in FIG. 10A and training the image frequency-domain autoencoder 122 in FIG. 12A, so the detailed content will not be repeated here.

Different from the foregoing embodiments, in the apparatus for equipment anomaly detection of the embodiment, weights in the trained image encoder and the image frequency-domain encoder are fixed and the outlier detection model is connected to train the outlier detection model.

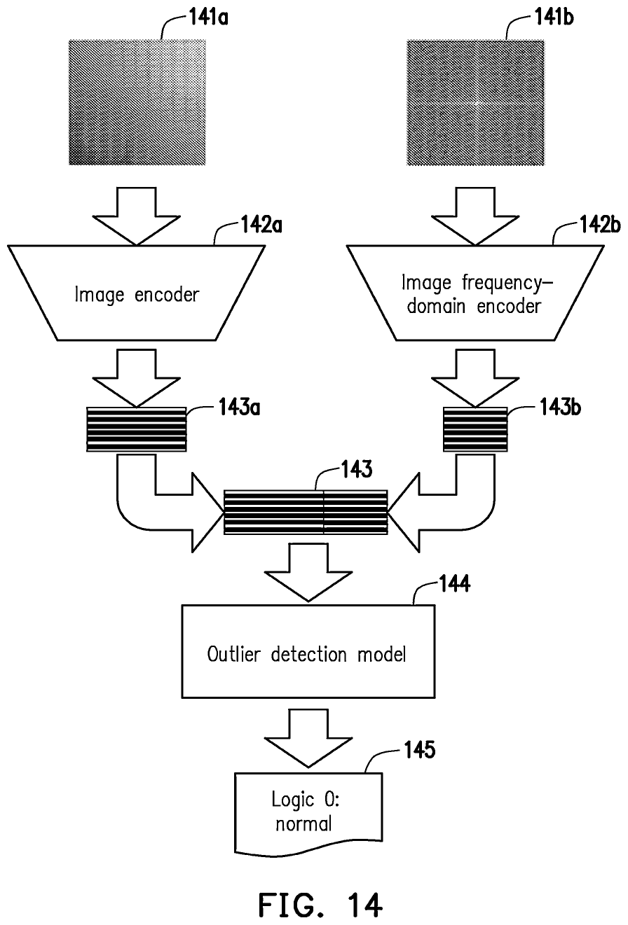

FIG. 14 is an example of training a machine learning model according to an embodiment of the disclosure. Please refer to FIG. 14. An apparatus for equipment anomaly detection acquires an appearance images 141a when an equipment appearance is not damaged by using a camera, and executes fast Fourier transform (FFT) on the appearance images 141a to be transformed into a two-dimensional image frequency-domain signals 141b. The appearance images 141a and the two-dimensional image frequency-domain signals 141b are respectively input into a trained image encoder 142a and an image frequency-domain encoder 142b to output compressed representation data 143a of the encoded appearance images 141a and compressed representation data 143b of the two-dimensional image frequency-domain signals 141b. Then, the compressed representation data 143a of the appearance image 141a and the compressed representation data 143b of the two-dimensional image frequency-domain signal 141b are spliced into compressed representation data 143. The spliced compressed representation data 143 is input into an outlier detection model 144 and the output of the outlier detection model 144 is set as a detection result 145 of normal appearance state (for example, logic 0), so as to train the outlier detection model 144.

Through the above method, in the embodiment of the disclosure, the machine learning model is trained by using the appearance images when the equipment appearance is not damaged and the transformed two-dimensional image frequency-domain signal without the need to collect or use data when the equipment appearance is damaged. Therefore, the issue of the low accuracy of the machine learning model caused by unbalanced data categories can be solved.

Table 2 below is an accuracy comparison table of a machine learning model adopting image training (hereinafter referred to as an image model), a machine learning model adopting two-dimensional image frequency-domain signal training (hereinafter referred to as an image frequency-domain model), and a machine learning model simultaneously adopting image signal and two-dimensional image frequency-domain signal training (hereinafter referred to as a hybrid model) according to an embodiment of the disclosure. In the embodiment, the outlier detection model is a one-class support vector machine (OCSVM) model, but not limited thereto. It can be seen from Table 2 that for prediction through the image model of the embodiment of the disclosure, the inference accuracy of normal images is 94.00% and the inference accuracy of abnormal images is 80.00%; for prediction through the two-dimensional image frequency-domain model of the embodiment of the disclosure, the inference accuracy of normal images is 89.50% and the inference accuracy of abnormal images is 100.0%; however, for prediction through the hybrid model of the embodiment of the disclosure, the inference accuracy of normal images is 95.75% and the inference accuracy of abnormal images is 100.00%. In other words, for prediction by the hybrid model simultaneously adopting image and two-dimensional image frequency-domain signal training, better accuracy can be obtained in the prediction of both normal and abnormal signals.

TABLE 2

| | Accuracy | Accuracy |
|---|---|---|
| Model | (normal images) | (abnormal images) |
| Image model | 94.00% | 80.00% |
| Two-dimensional image | 89.50% | 100.0% |
| frequency-domain model | | |
| Hybrid model | 95.75% | 100.0% |

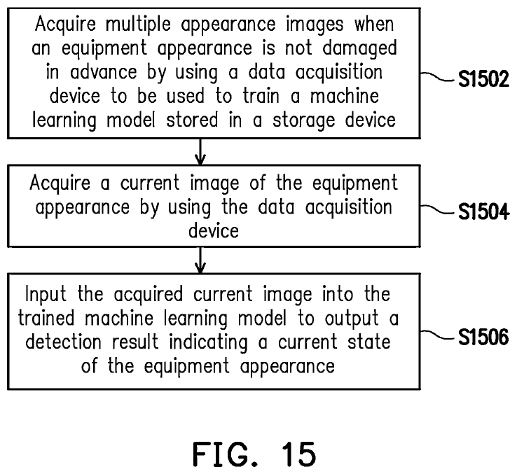

FIG. 15 is a flowchart of a method for equipment anomaly detection according to an embodiment of the disclosure. Please refer to FIG. 1 and FIG. 15 at the same time. The method of the embodiment is applicable to the apparatus for equipment anomaly detection 10 of FIG. 1. The detailed steps of the method for equipment anomaly detection of the embodiment of the disclosure will be described below in conjunction with various elements of the apparatus for equipment anomaly detection 10.

In Step S1502, the processor 16 of the apparatus for equipment anomaly detection 10 acquires multiple appearance images of the equipment 20 when the appearance is not damaged by using the data acquisition device 12 to be used to train a machine learning model stored in the storage device 14. In some embodiments, the machine learning model is formed by connecting an encoder composed of a neural network to an outlier detection model. The outlier detection model is, for example, a one-class support vector machine, an isolation forest, a local outlier factor, etc., but not limited thereto.

In Step S1504, the processor 16 acquires a current image of the appearance of the equipment 20 by using the data acquisition device 12.

In Step S1506, the processor 16 inputs the acquired current image into the machine learning model to output a detection result indicating a current state of the appearance of the equipment 20. In the embodiment, a large number of images of the equipment 20 when the appearance is not damaged is collected and used to train the machine learning model, so that even in the absence of images of the equipment 20 when the appearance is damaged, the machine learning model can still distinguish the abnormal state of the appearance of the equipment 20 by itself, thereby achieving the objective of intelligent pre-diagnosis.

In summary, the method and the apparatus for equipment anomaly detection according to the embodiments of the disclosure can distinguish the anomaly in function or equipment appearance through sensing and collecting a large amount of data of the equipment during normal operation or images when the appearance is not damaged to train the machine learning model, so as to achieve the goal of intelligent pre-diagnosis for equipment. The machine learning model of the embodiments of the disclosure can perform comprehensive prediction in conjunction with the image and image frequency-domain features of the signals to obtain better accuracy. Through storing the trained machine learning model in the apparatus for equipment anomaly detection and acquiring the current appearance image of the equipment, anomaly detection can be performed, thereby implementing edge computing and intelligent pre-diagnosis.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An apparatus for equipment anomaly detection, comprising:
a data acquisition device, acquiring a signal of an equipment during operation;
a storage device, storing a machine learning model; and
a processor, coupled to the data acquisition device and the storage device, and configured to:
acquire a plurality of signals of the equipment during normal operation in advance by using the data acquisition device to train the machine learning model;
acquire a real-time signal of the equipment during a current operation by using the data acquisition device; and
input the acquired real-time signal to the trained machine learning model to output a detection result indicating a current operation state of the equipment.

2. The apparatus for equipment anomaly detection according to claim 1, wherein the machine learning model is formed by connecting an encoder composed of a neural network to an outlier detection model (ODM), and the processor is configured to input the real-time signal to the encoder for feature extraction and dimension reduction to output compressed representation data, and input the compressed representation data to the outlier detection model to distinguish the current operation state of the equipment and output the detection result.

3. The apparatus for equipment anomaly detection according to claim 2, wherein the processor is configured to:
acquire a plurality of time-domain signals of the equipment during normal operation by using the data acquisition device; and
train an autoencoder comprising the encoder and a decoder by using the time-domain signal, comprising:
performing feature extraction and dimension reduction on the time-domain signal by the encoder to output compressed representation data of the time-domain signal;
decoding the compressed representation data by the decoder to obtain a reconstructed time-domain signal; and
calculating a loss function between the time-domain signal and the reconstructed time-domain signal to train the encoder.

4. The apparatus for equipment anomaly detection according to claim 3, wherein the processor is further configured to:
input the time-domain signal acquired by the data acquisition device to the trained encoder to output the compressed representation data; and
train the outlier detection model by using the compressed representation data.

5. The apparatus for equipment anomaly detection according to claim 2, wherein the processor is further configured to:
acquire a plurality of frequency-domain signals of the equipment during normal operation by using the data acquisition device; and
train an autoencoder comprising the encoder and a decoder by using the frequency-domain signal, comprising:
performing feature extraction and dimension reduction on the frequency-domain signal by the encoder to output compressed representation data of the frequency-domain signal;
decoding the compressed representation data by the decoder to obtain a reconstructed frequency-domain signal; and
calculating a loss function between the frequency-domain signal and the reconstructed frequency-domain signal to train the encoder.

6. The apparatus for equipment anomaly detection according to claim 5, wherein the processor is further configured to:
input the frequency-domain signal acquired by the data acquisition device to the trained encoder to output the compressed representation data; and
train the outlier detection model by using the compressed representation data.

7. The apparatus for equipment anomaly detection according to claim 5, wherein the frequency-domain signal is obtained by the processor performing fast Fourier transform (FFT) on a time-domain signal acquired by the data acquisition device or is directly acquired by the data acquisition device.

8. The apparatus for equipment anomaly detection according to claim 1, wherein the machine learning model is formed by connecting a time-domain encoder and a frequency-domain encoder composed of a neural network to an outlier detection model, and the processor is configured to:
acquire a plurality of time-domain signals and a plurality of frequency-domain signals of the equipment during normal operation by using the data acquisition device;
train a time-domain autoencoder comprising the time-domain encoder and a time-domain decoder by using the time-domain signal, comprising: performing feature extraction and dimension reduction on the time-domain signal by the time-domain encoder to output compressed representation data of the time-domain signal, decoding the compressed representation data of the time-domain signal by the time-domain decoder to obtain a reconstructed time-domain signal, and calculating a first loss function between the time-domain signal and the reconstructed time-domain signal to train the time-domain autoencoder; and
train a frequency-domain autoencoder comprising the frequency-domain encoder and a frequency-domain decoder by using the frequency-domain signal, comprising: performing feature extraction and dimension reduction on the frequency-domain signal by the frequency-domain encoder to output compressed representation data of the frequency-domain signal, decoding the compressed representation data of the frequency-domain signal by the frequency-domain decoder to obtain a reconstructed frequency-domain signal, and calculating a second loss function between the frequency-domain signal and the reconstructed frequency-domain signal to train the frequency-domain autoencoder.

9. The apparatus for equipment anomaly detection according to claim 8, wherein the processor is further configured to:
respectively input the time-domain signal and the frequency-domain signal acquired by the data acquisition device to the trained time-domain encoder and trained frequency-domain encoder to output the compressed representation data of the time-domain signal and the frequency-domain signal; and
concatenate the compressed representation data of the time-domain signal and the frequency-domain signal, and train the outlier detection model by using the concatenated compressed representation data.

10. The apparatus for equipment anomaly detection according to claim 1, wherein the signal comprises a voltage signal, a current signal, a sound signal, or a vibration signal.

11. A method for equipment anomaly detection, applicable to an electronic device comprising a data acquisition device, a storage device, and a processor, the method comprising:
acquiring a plurality of signals of an equipment during normal operation in advance by using the data acquisition device to train a machine learning model stored in the storage device;
acquiring a real-time signal of the equipment during a current operation by using the data acquisition device; and
inputting the acquired real-time signal to the trained machine learning model to output a detection result indicating a current operation state of the equipment.

12. The method according to claim 11, wherein the machine learning model is formed by connecting an encoder composed of a neural network to an outlier detection model, and the step of inputting the acquired real-time signal to the trained machine learning model to output the detection result indicating the current operation state of the equipment comprises:
inputting the real-time signal to the encoder for feature extraction and dimension reduction to output compressed representation data; and
inputting the compressed representation data to the outlier detection model to distinguish the current operation state of the equipment and output the detection result.

13. The method according to claim 12, wherein the step of acquiring the signals of the equipment during normal operation in advance by using the data acquisition device to train the machine learning model stored in the storage device comprises:
acquiring a plurality of time-domain signals of the equipment during normal operation by using the data acquisition device; and
training an autoencoder comprising the encoder and a decoder by using the time-domain signal, comprising:
performing feature extraction and dimension reduction on the time-domain signal by the encoder to output compressed representation data of the time-domain signal;
decoding the compressed representation data by the decoder to obtain a reconstructed time-domain signal; and
calculating a loss function between the time-domain signal and the reconstructed time-domain signal to train the encoder.

14. The method according to claim 13, wherein the step of acquiring the signals of the equipment during normal operation in advance by using the data acquisition device to train the machine learning model stored in the storage device further comprises:
inputting the time-domain signal acquired by the data acquisition device to the trained encoder to output the compressed representation data; and
training the outlier detection model by using the compressed representation data.

15. The method according to claim 12, wherein the step of acquiring the signals of the equipment during normal operation in advance by using the data acquisition device to train the machine learning model stored in the storage device comprises:
acquiring a plurality of frequency-domain signals of the equipment during normal operation by using the data acquisition device; and
training an autoencoder comprising the encoder and a decoder by using the frequency-domain signal, comprising:
performing feature extraction and dimension reduction on the frequency-domain signal by the encoder to output compressed representation data of the frequency-domain signal;
decoding the compressed representation data by the decoder to obtain a reconstructed frequency-domain signal; and
calculating a loss function between the frequency-domain signal and the reconstructed frequency-domain signal to train the encoder.

16. The method according to claim 15, wherein the step of acquiring the signals of the equipment during normal operation in advance by using the data acquisition device to train the machine learning model stored in the storage device further comprises:
inputting the frequency-domain signal acquired by the data acquisition device to the trained encoder to output the compressed representation data; and
training the outlier detection model by using the compressed representation data.

17. The method according to claim 15, wherein the frequency-domain signal is obtained by performing fast Fourier transform on the time-domain signal acquired by the data acquisition device or is directly acquired by the data acquisition device.

18. The method according to claim 11, wherein the step of acquiring the signals of the equipment during normal operation in advance by using the data acquisition device to train the machine learning model stored in the storage device comprises:
acquiring a plurality of time-domain signals and a plurality of frequency-domain signals of the equipment during normal operation by using the data acquisition device;
training a time-domain autoencoder comprising the time-domain encoder and a time-domain decoder by using the time-domain signal, comprising: performing feature extraction and dimension reduction on the time-domain signal by the time-domain encoder to output compressed representation data of the time-domain signal, decoding the compressed representation data of the time-domain signal by the time-domain decoder to obtain a reconstructed time-domain signal, and calculating a first loss function between the time-domain signal and the reconstructed time-domain signal to train the time-domain autoencoder; and
training a frequency-domain autoencoder comprising the frequency-domain encoder and a frequency-domain decoder by using the frequency-domain signal, comprising: performing feature extraction and dimension reduction on the frequency-domain signal by the frequency-domain encoder to output compressed representation data of the frequency-domain signal, decoding the compressed representation data of the frequency-domain signal by the frequency-domain decoder to obtain a reconstructed frequency-domain signal, and calculating a second loss function between the frequency-domain signal and the reconstructed frequency-domain signal to train the frequency-domain autoencoder.

19. The method according to claim 18, wherein the step of acquiring the signals of the equipment during normal operation in advance by using the data acquisition device to train the machine learning model stored in the storage device further comprises:
respectively inputting the time-domain signal and the frequency-domain signal acquired by the data acquisition device to the trained time-domain encoder and trained frequency-domain encoder to output the compressed representation data of the time-domain signal and the frequency-domain signal; and
concatenating the compressed representation data of the time-domain signal and the frequency-domain signal, and training the outlier detection model by using the concatenated compressed representation data.

20. The method according to claim 11, wherein the signal comprises a voltage signal, a current signal, a sound signal, or a vibration signal.

21. An apparatus for equipment anomaly detection, comprising:
a data acquisition device, acquiring an appearance image of an equipment;
a storage device, storing a machine learning model; and
a processor, coupled to the data acquisition device and the storage device, and configured to:
acquire a plurality of appearance images of the equipment when an appearance is not damaged in advance by using the data acquisition device to be used to train the machine learning model;
acquire a current image of the appearance of the equipment by using the data acquisition device; and
input the acquired current image into the trained machine learning model to output a detection result indicating a current state of the appearance of the equipment.

22. The apparatus for equipment anomaly detection according to claim 21, wherein the machine learning model is formed by connecting an encoder composed of a neural network to an outlier detection model, and the processor is configured to input the current image into the encoder to perform feature extraction and dimension reduction to output compressed representation data, and input the compressed representation data into the outlier detection model to distinguish a current state of the appearance of the equipment and output the detection result.

23. The apparatus for equipment anomaly detection according to claim 22, wherein the processor is configured to:
train an autoencoder comprising the encoder and a decoder by using the appearance images, comprising:
performing feature extraction and dimension reduction on the appearance images by the encoder to output compressed representation data of the appearance images;
decoding the compressed representation data by the decoder to obtain a plurality of reconstructed appearance images; and
calculating a loss function between the appearance images and the reconstructed appearance images to be used to train the autoencoder.

24. The apparatus for equipment anomaly detection according to claim 22, wherein the processor is further configured to:
perform fast Fourier transform on the appearance images acquired by the data acquisition device to obtain a plurality of two-dimensional image frequency-domain signals of the appearance images; and
train an autoencoder comprising the encoder and a decoder by using the two-dimensional image frequency-domain signals, comprising:
performing feature extraction and dimension reduction on the two-dimensional image frequency-domain signals by the encoder to output compressed representation data of the two-dimensional image frequency-domain signals;
decoding the compressed representation data by the decoder to obtain a reconstructed two-dimensional image frequency-domain signals; and
calculating a loss function between the two-dimensional image frequency-domain signals and the reconstructed two-dimensional image frequency-domain signals to be used to train the autoencoder.

25. The apparatus for equipment anomaly detection according to claim 22, wherein the machine learning model is formed by combining an image encoder composed of a neural network with an image frequency-domain encoder composed of a neural network, and the processor is configured to:
train an image autoencoder comprising the image encoder and an image decoder by using the appearance images, comprising performing feature extraction and dimension reduction on the appearance images by the image encoder to output compressed representation data of the appearance images, decoding the compressed representation data of the appearance images by the image decoder to obtain a reconstructed appearance images, and calculating a first loss function between the appearance images and the reconstructed appearance images to be used to train the image autoencoder; and
train an image frequency-domain autoencoder comprising the image frequency-domain encoder and an image frequency-domain decoder by using the two-dimensional image frequency-domain signals, comprising performing feature extraction and dimension reduction on the two-dimensional image frequency-domain signals by the image frequency-domain encoder to output compressed representation data of the two-dimensional image frequency-domain signals, decoding the compressed representation data of the two-dimensional image frequency-domain signals by the image frequency-domain decoder to obtain a reconstructed two-dimensional image frequency-domain signals, and calculating a second loss function between the two-dimensional image frequency-domain signals and the reconstructed two-dimensional image frequency-domain signals to be used to train the image frequency-domain autoencoder.

26. The apparatus for equipment anomaly detection according to claim 25, wherein the processor is further configured to:
respectively input the appearance images acquired by the data acquisition device and the two-dimensional image frequency-domain signals obtained after transforming the appearance images via fast Fourier transform (FFT) into the trained image encoder and the image frequency-domain encoder to output compressed representation data of the appearance images and the two-dimensional image frequency-domain signals; and
splice the compressed representation data of the appearance images and the two-dimensional image frequency-domain signals, and train the outlier detection model by using the spliced compressed representation data.

27. A method for equipment anomaly detection, applicable to an electronic device comprising a data acquisition device, a storage device, and a processor, the method comprising:
acquiring a plurality of appearance images of an equipment when an appearance is not damaged in advance by using the data acquisition device to be used to train a machine learning model stored in the storage device;
acquiring a current image of the appearance of the equipment by using the data acquisition device; and
inputting the acquired current image into the trained machine learning model to output a detection result indicating a current state of the appearance of the equipment.

28. The method according to claim 27, wherein the machine learning model is formed by connecting an encoder composed of a neural network to an outlier detection model, and the processor is configured to input the current image into the encoder to perform feature extraction and dimension reduction to output compressed representation data, and input the compressed representation data into the outlier detection model to distinguish a current state of the appearance of the equipment and output the detection result.

29. The method according to claim 28, comprising:
training an autoencoder comprising the encoder and a decoder by using the appearance images, comprising:
performing feature extraction and dimension reduction on the appearance images by the encoder to output compressed representation data of the appearance images;
decoding the compressed representation data by the decoder to obtain a plurality of reconstructed appearance images; and
calculating a loss function between the appearance images and the reconstructed appearance images to be used to train the autoencoder.

30. The method according to claim 28, further comprising:
performing fast Fourier transform (FFT) on the appearance images acquired by the data acquisition device to obtain a plurality of two-dimensional image frequency-domain signals of the appearance images; and
training an autoencoder comprising the encoder and a decoder by using the two-dimensional image frequency-domain signals, comprising:
performing feature extraction and dimension reduction on the two-dimensional image frequency-domain signals by the encoder to output compressed representation data of the two-dimensional image frequency-domain signals;
decoding the compressed representation data by the decoder to obtain a plurality of reconstructed two-dimensional image frequency-domain signals; and
calculating a loss function between the two-dimensional image frequency-domain signals and the reconstructed two-dimensional image frequency-domain signals to be used to train the autoencoder.

31. The method according to claim 28, wherein the machine learning model is formed by combining an image encoder composed of a neural network with an image frequency-domain encoder composed of a neural network, the method comprising:
training an image autoencoder comprising the image encoder and an image decoder by using the appearance images, comprising performing feature extraction and dimension reduction on the appearance images by the image encoder to output compressed representation data of the appearance images, decoding the compressed representation data of the appearance images by the image decoder to obtain a plurality of reconstructed appearance images, and calculating a first loss function between the appearance images and the reconstructed appearance images to be used to train the image autoencoder; and
training an image frequency-domain autoencoder comprising the image frequency-domain encoder and an image frequency-domain decoder by using the two-dimensional image frequency-domain signals, comprising performing feature extraction and dimension reduction on the two-dimensional image frequency-domain signals by the image frequency-domain encoder to output compressed representation data of the two-dimensional image frequency-domain signals, decoding the compressed representation data of the two-dimensional image frequency-domain signals by the image frequency-domain decoder to obtain a reconstructed two-dimensional image frequency-domain signals, and calculating a second loss function between the two-dimensional image frequency-domain signals and the reconstructed two-dimensional image frequency-domain signals to be used to train the image frequency-domain autoencoder.

32. The method according to claim 31, further comprising:
respectively inputting the appearance images acquired by the data acquisition device and the two-dimensional image frequency-domain signals obtained after transforming the appearance images via fast Fourier transform (FFT) into the trained image encoder and the image frequency-domain encoder to output compressed representation data of the appearance images and the two-dimensional image frequency-domain signals; and
splicing the compressed representation data of the appearance images and the two-dimensional image frequency-domain signals, and training the outlier detection model by using the spliced compressed representation data.
